(19) United States
(12) Patent Application Publication
(10) Pub. No.: US 2025/0254457 A1
(43) Pub. Date: Aug. 7, 2025

(54) CHARGER DEVICE FOR HEARING DEVICES

(71) Applicant: Oticon A/S, Smørum (DK)

(72) Inventors: Lars Steen CHRISTENSEN, Smørum (DK); Pernille Randrup VERGMANN, Smørum (DK); Sebastian Vedsø WILLEMS, Smørum (DK); Anders THOMASEN, Smørum (DK); Thomas PEDERSEN, Smørum (DK); Lars RIEMER, Smørum (DK)

(21) Appl. No.: 19/042,021

(22) Filed: Jan. 31, 2025

(30) Foreign Application Priority Data
Feb. 5, 2024 (EP) 24155831.1

(51) Int. Cl. H04R 1/10; H02J 7/00

(52) U.S. Cl. CPC H04R 1/1025; H02J 7/00034; H02J 7/0044; H04R 1/1058

(57) ABSTRACT

Disclosed herein are embodiments of a charger device for charging one or more hearing devices. The charging device includes a charger housing having a particular charging interface, a power inlet configured for receiving an external cable, and a substrate configured to hold the power inlet. A number of connector legs can be used for connection, where at least one connector leg includes a bent tip.

### CROSS REFERENCE TO RELATED APPLICATIONS

Any and all application for which a foreign or domestic priority claim is identified in the Application Data Sheet as filed with the present application are hereby incorporated by reference under 37 CFR 1.57

### FIELD

The present disclosure relates to a charger device configured to charge one or more hearing devices. More particularly, the disclosure relates to a charger device for wireless or wired charging of hearing devices, such as a single hearing device or a set of hearing device. The hearing device may be a hearing aid or an earbud/hearable or the like ear level device.

### BACKGROUND

When charging a device configured to be positioned at an ear of a user, such as a hearing aid or a hearing device or an earbud, either via a wire or wirelessly, using a charger device, the charger device needs power. This could be provided from an internal battery or an external source. An external source may also be used to charge an internal battery, either wired or wirelessly. When using an external power source, either for charging a hearing aid or an internal battery of the charger, the external power source needs an interface. This interface could be based on an USB-type interface, such as a USB-C type interface. The interface preferably detachably connects to a cable, and as users remove such a cable from the interface, a pull-force is exerted on the interface. Thus, there is a risk that the interface break.

Therefore, there is a need to provide a solution that addresses at least some of the above-mentioned problems. The present disclosure provides at least an alternative to the prior art.

### SUMMARY

The present disclosure related to a charger device for (re) charging a hearing device. The charger device may be powered by a mains connection, such as a low-voltage connection. The charger device may comprise a battery configured to provide charge power to the hearing device when no mains connection is present or available, such as while the user is travelling or the like. The internal battery may then be charged when the charger is connected to an external power supply, such as a mains power supply. The mains power may be provided from e.g. a 12/24V car supply or a 110/220 V wall socket or the like, or a 5V USB connection to a computer or suitable power supply. The charger device may comprise one or more visual indicators, such as LED lights and/or a graphic display. The visual indicators may be used to communicate information such as “device present”, “device being charged”, “device partial charge status”, “device fully charged”. The charger device may comprise a data interface configured to communicate with a server device for providing e.g. software/setting update to the hearing device, such as firmware updates etc. or may be configured to collect data from a hearing device, such as use data, status data, crash data etc. Such collected data may e.g. be stored in the charger device until the device is examined/read at a hearing health care professional or service personnel, or, may be communicated from the charger device via a communications interface either directly via e.g. WIFI or via a connection though a smartphone, to e.g. a server or the like. In such cases, the charger device may include a wireless interface, such as WiFi and/or Bluetooth or another suitable communication interface.

In a first aspect, the present disclosure relates to a charging device configured to receive a hearing device, such as a hearing aid, wherein the charging device comprises a charger housing having a reception part configured to receive at least part of the hearing device. The charging device according to the present disclosure may further comprise a power inlet arranged at an opening at the charger housing. The power inlet may have an opening configured to receive a specific connector, either a male or female connector. The power inlet may define a power inlet axis or direction. This axis could coincide with an insert direction for the power inlet. This means that when a user inserts a power cable, the plug of the power cable is inserted in the insert direction, along the power inlet axis, into the power inlet (socket). This could mean that when inserting e.g. a plug into the power inlet, the insertion direction would be along the inlet axis. The charging device according to the present disclosure may further comprise a substrate arranged within the charger housing. The substrate may define a substrate surface, or simply surface. The substrate could define a first surface and an opposite second surface. These two surfaces, first and second surfaces, would be the large surfaces (as opposite to an edge side) where e.g. various electronic components would/could be mounted. At one side, e.g. the first side, the power inlet could be mounted, such as the power inlet could be mounted to the surface of the substrate so that the power inlet axis is substantially perpendicular to the surface of the substrate. The surface of the substrate, or at least a part thereof, would preferably be substantially flat. The power inlet may comprise a front end, configured to receive a charger cable, or other suitable input, and a backend. The backend, or back side, may be configured or fitted with a plurality of connector legs extending from a power inlet body. The connector leg or legs may be small extensions of the body making up an outer surface of the power inlet. In a mounted state, the connector legs may be arranged to extend through the substrate, such as through a hole or opening in the substrate. The connector legs may have a tip, or distal end, which may then be bent to abut the substrate, such as to abut a backside or opposite side of the substrate, such as the side of the substrate opposite the side where the connector is mounted to. This is contemplated to provide a retention force when the power inlet is being pulled during a process where the user intends to remove a cable connected to the power inlet. It is especially advantageous in a situation where electrical power supplied through the inlet while heating the inlet to a temperature above a melting point of a material such as a soldering material used to retain the inlet and/or provide/improve electrical connection.

The charger device according to the present disclosure provides an easy and simple method for fixation of a connector to a PCB/substrate which will stay fixated and not risk being pulled out of the charger even if the solder joints are overheated and melted, which may happen if a user connects a USB connector which provides a too-high voltage. The charging device may e.g. be configured to receive 5 V, but if the power inlet is a USB-C type interface a user may mistakenly connect a USB-C connector which provides e.g. 48 V, such as on adapted for powering a laptop. The high voltage/power may (over-) heat the connector which in turn melt soler material and thereby loosen the connector from the substrate.

The connector legs may be non-conductive. The connector legs are preferably part of a housing of the power receiver.

Adhesive or solder may be provided at the connector legs. This is contemplated to improve the force needed to remove or dislodge the power inlet, which would improve the reliability of the charger device.

A spacer may be provided between the substrate and the power inlet.

The charging device may comprise a charger antenna element configured to cooperate with an antenna in the hearing device to be charged so that the performance of the hearing device antenna is increased. This could help a hearing device being charged to achieve an improve communication range, such as communication to a user's mobile phone or other computing device. The charger antenna may be incorporated in a charging device without the bent pins as disclosed herein. The charger antenna is contemplated to be useful in that hearing devices, such as hearing aids, have limited space for a BLE (Bluetooth) antenna. Especially completely-in-canal style hearing devices need to be very compact. While the hearing device is in a charger, it is advantageous to have an extended BLE range, so the user can check e.g. the hearing device charge state from the next room. A true BLE quarter-wave antenna should have a length around 30 mm, but a completely-in-the-canal hearing device, or even a behind-the-ear hearing device, usually does not have room to accommodate this length of antennas.

When a hearing device is inserted into a charger, the charger may establish a galvanic contact to the hearing device. By e.g. adding an additional contact point and possibly some wiring and circuitry, the BLE antenna in the HI may be extended, either passively or actively. This increases the BLE range. Instead of a third contact point, one of the existing contact points could be used. This is possible because BLE is in the GHz range, and charging is DC so that separation of these two signals is relatively easy by filtering. The charger antenna may either extend the hearing device's internal antenna (contact point at the end of the hearing device antenna), or overriding/supplementing the internal antenna (contact point at beginning of hearing device antenna).

The charger could also supply the whole antenna function: If the hearing device detects that it is in a charger, it could shut down its own antenna. The charger-to-hearing device communication could be in RF (pure antenna signals) or baseband (so the charger modulates and amplifies to RF). This could also apply to other radio signals than BLE type, such as Classic Bluetooth and/or UWB.

The charging device advantageously comprises a charging interface configured to interface with the hearing device to be charged. The charging interface is then configured to provide output power, and wherein the charging interface is further configured to connect to a charger cradle configured to connect to a hearing aid to be charged, wherein a wire and connector is configured to connect to the charging interface during use.

The charging device may comprise a battery configured to provide power via the charging interface. This could be useful for charging a hearing while it is still in use at the user's ear. By enabling charging with the hearing device while active on the ear, the user can avoid range anxiety.

The charger slot inserts could be made removeable, or additional/specialized connectors may be provided. Further, extended wires between the charger and the insert could be provided. The charger may additionally be able to be hung around the neck, such as in a neckband. The charge slots may be made as slim as possible so as to be unobtrusive. The wires could be made to look like an in-ear headset. The charger case should have indicator LEDs for the HD charging state (orange when charging, green when charging finished). The solution could also include an adapter that fits into the slots on the charger, and has wires leading up to the hearing device/adaptor on the ears. This adapter could be stored in the cavity in the charger. The adapter could be separate to the charger.

The charging device according to the present disclosure may comprise a wireless interface configured to receive a wireless communication from an external device. Over-The-Air (OTA) updating of the firmware in a charger is desirable, but requires some sort of radio connection. This adds cost and complexity to the charger. The hearing device usually already have a radio and possibly connection to a smartphone, and already have an OTA update capability. The charger has a (galvanic) connection to the hearing device, and the hearing devices are in the charger for a long time (typically every night/all night). The hearing device and charger are able to communicate via a galvanic interface communicate. By letting the hearing device act as an intermediary in the updating of firmware of the charger, no extra component cost is incurred. The charging device further being configured to the wireless communication to a hearing device being charged. The wireless communication may comprise software updates and/or settings updates to the hearing device and/or the charger device.

A hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal. The hearing aid may comprise an output unit for providing a stimulus perceived by the user as an acoustic signal based on a processed electric signal. The output unit may a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 KHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

The hearing aid may comprise a movement detector, e.g. an acceleration sensor. The movement detector may be configured to detect movement of the user's facial muscles and/or bones, e.g. due to speech or chewing (e.g. jaw movement) and to provide a detector signal indicative thereof. The hearing aid may be configured to enter certain modes based on signal from the moment detector.

The present disclosure relates to a charging device configured to receive a hearing device, such as a hearing aid, wherein the charging device comprises: a charger housing having a reception part configured to receive at least part of the hearing device, a power inlet arranged with an opening at the charger housing, the power inlet defining a power inlet axis, a substrate arranged within the charger housing, the substrate defining a substrate surface, wherein the power inlet is mounted to the substrate surface and the power inlet axis is substantially perpendicular to the substrate surface, wherein the power inlet comprises a front end configured to receive a charger cable and a back end configured with a plurality of connector legs extending from a power inlet body, wherein in a mounted state, the connector legs extend through the substrate, the connector legs having a tip which is bend to abut the substrate. Such a charger device and/or hearing aid may include any of the features mentioned throughout the present disclosure.

The hearing aid may comprise a hearing instrument, e.g. a hearing instrument adapted for being located at the ear or fully or partially in the ear canal of a user, e.g. a headset, an earphone, an ear protection device or a combination thereof. A hearing system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows a hearing aid;

FIG. 2 schematically shows a substrate in a charger device and a power inlet according to the present disclosure:

FIG. 3 schematically shows steps of inserting attaching a power inlet to a substrate; and

FIG. 4 shows a charger substrate with four connector legs.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids and specifically in the field of chargers for hearing aids.

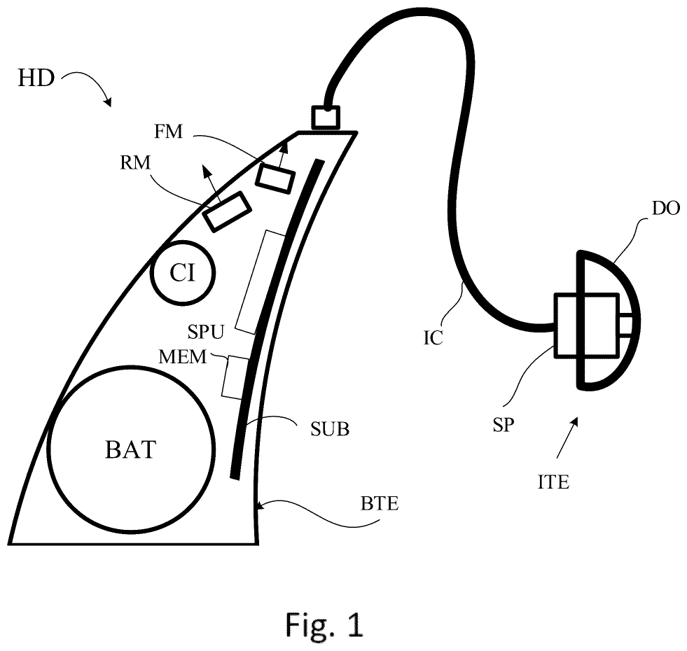

FIG. 1, schematically illustrates a hearing device HD, where the hearing device is shaped as a hearing aid of the behind-the-ear hearing aid. As disclosed herein, the hearing device may be provided in other form-factors and without hearing loss compensation, i.e. as a earphone e.g. for music and/or phone conversation as a wireless headset. The hearing device HD comprises an interconnection member IC connecting a behind-the-ear housing BTE with an in-the-ear housing ITE. Two microphones constitute an input system for the hearing device, which are connected to a processor SPU and a memory MEM arranged in connection with a substrate SUB. A battery BAT powers the hearing device. Here the battery BAT is a secondary battery, i.e. rechargeable.

The hearing device HD comprises a charge interface CI configured to receive power from an external source and provide this as charging power to the battery during a recharging process. The charge interface CI may be a wired interface and/or a wireless interface. A wired part of such a charge interface may include one or more, such as two, pins which are configured to connect to corresponding pads in a charger device. A wireless part of a charge interface may include one or more coils configured to receive a wireless charge field emitted by a charger device having a charge coil. The charge interface CI may be connected through a converter in order to charge the battery BAT.

The hearing device HD may comprise an RF antenna in connection with a suitable wireless interface, such as a radio configured to communicate using a data protocol, such as Bluetooth/Bluetooth Low Energy or the like. The hearing device HD may comprise an inductive communication interface with a coil, wherein the inductive communication interface is configured to communicate with a hearing device to be placed at the contralateral ear of a user. The inductive communication interface may be configured to communicate with other devices than another hearing device. The coil for the inductive communication interface may be the same coil as the charger interface coil used to pick up wireless charge energy. Insert assemblies are used to be fixated by screws which is time consuming in production. We have also seen issues with cracked and broken screw towers. So, an easier way of mounting and fixate the inserts are good for both production and reliability. Also moulding of this solution is simpler than traditional snap solutions.

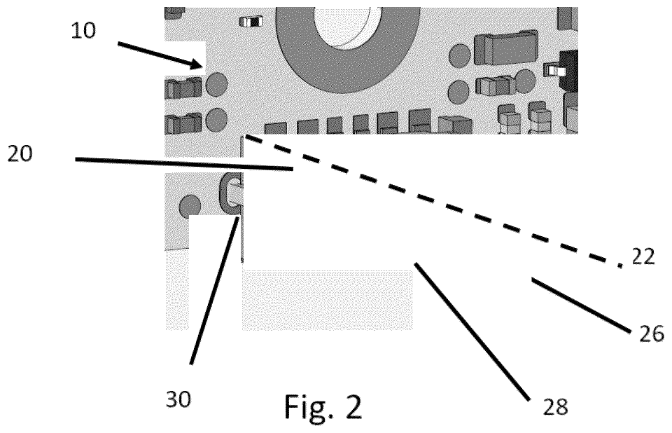

FIG. 2 schematically illustrates a substrate 10 of charger device. The charging device is configured to receive a hearing device and provide power the built-in battery thereby recharging it. In a charger housing a reception part is configured to receive at least part of the hearing device, and establish a power connection thereto, either via contact pins or wireless coils for charging. The charger device comprises a power inlet 20 arranged with an opening 26 at the charger housing. The power inlet 20 defines a power inlet axis 22.

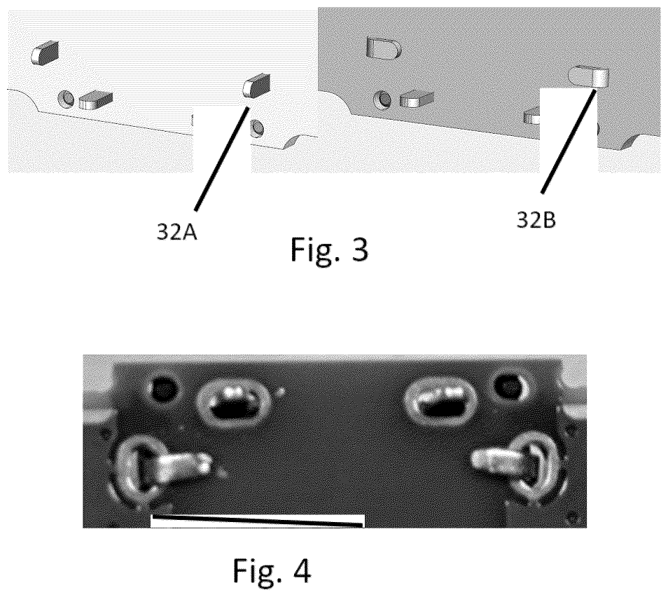

The substrate 10 is arranged within the charger housing. The substrate defines a surface of the substrate. The power inlet 20 is mounted to the substrate 10 surface and the power inlet 22 axis is substantially perpendicular to the surface of the substrate. The power inlet 20 comprises a front end 28 configured to receive a charger cable and a backend 30 configured with a plurality of connector legs extending from a power inlet body. In a mounted state, the connector legs extend through the substrate, as illustrated in FIGS. 3 and 4. The connector legs having a tip or distal end which is bent to abut the substrate.

FIG. 3 schematically illustrates two states of a power inlet being mounted to a substrate. At 32A a tip or distal end of a connector leg extending through a hole or opening in the substrate. In this state, the tip is unbent and simply extends straight out of the hope. At 32B the tip or distal end is bent so that it abuts or touch the substrate. With this angle on the connector leg an additional force is needed to remove/separate the connector and substrate. By bending two such legs, as illustrated at the right-hand side of FIG. 3, even further force is needed. This increases the safety of the charger device as the risk of the power inlet (body) being dislodged from the mounted state. In FIG. 4,it is seen that two legs are bent while two others extend straight. To further increase safety, adhesive or solder may be provided at the connector legs.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A charging device configured to receive a rechargeable hearing aid, wherein the charging device comprises:
a charger housing, the charger housing having a reception part configured to receive at least part of the hearing device, wherein a charging interface is arranged in the reception part and wherein the hearing aid includes a charge reception interface arranged so that the charging interface and the charge reception interface are in contact when the hearing aid is positioned in the reception part,
a power inlet having an power inlet opening and an opposite attachment end, the power inlet being arranged with the power inlet opening at the charger housing, the power inlet opening being configured to receive a plug of an external cable,
a substrate arranged within the charger housing, the substrate defining a surface, wherein the power inlet is mounted to the surface of the substrate with the attachment end at the substrate surface, wherein the attachment end being configured with a plurality of connector legs extending from a power inlet body, wherein in a mounted state, the connector legs extend through the substrate, at least one of the connector legs having a tip which is bend to abut the substrate.

2. The charging device according to claim 1, wherein in the mounted state, the tip abut a side of the substrate opposite the surface where the power inlet is mounted.

3. The charging device according to claim 1, wherein the connector legs are non-conductive.

4. The charging device according to claim 1, wherein adhesive or solder is provided at the connector legs.

5. The charging device according to claim 1, wherein a spacer is provided between the substrate and the power inlet.

6. The charging device according to claim 1, wherein the charging device comprises a charger antenna element configured to cooperate with an antenna in the hearing device to be charged so that the performance of the hearing device antenna is increased.

7. The charging device according to claim 1, wherein charging device comprises a charging interface configured to interface with the hearing device to be charged, wherein the charging interface is configured to provide output power, and wherein the charging interface is further configured to connect to a charger cradle configured to connect to a hearing aid to be charged, wherein a wire and connector is configured to connect to the charging interface during use.

8. The charging device according to claim 5, wherein the charging device comprises a battery configured to provide power via the charging interface.

9. The charging device according to claim 1, wherein the charging device further comprises a communication interface configured to receive a communication from an external device via a hearing device being stored in the charger device.

10. The charging device according to claim 9, wherein the wireless communication comprises software updates and/or settings updates to the hearing device and/or the charger device.

11. A charging device configured to receive a hearing device, such as a hearing aid, wherein the charging device comprises:
a charger housing having a reception part configured to receive at least part of the hearing device,
a power inlet arranged with an opening at the charger housing, the power inlet having a power inlet opening configured to receive a plug,
a substrate arranged within the charger housing, the substrate defining a first surface and an opposite second surface, wherein the power inlet is mounted to the first surface and the power inlet is arranged substantially perpendicular to the surface of the substrate, wherein the power inlet comprises a front end configured to receive a charger cable and a back end configured with a plurality of connector legs extending from a power inlet body, wherein in a mounted state, the connector legs extend through the substrate, at least one of the connector legs having a tip which is bend to abut the second surface of the substrate.
